(19) United States
(12) Patent Application Publication
(10) Pub. No.: US 2004/0197614 A1
(43) Pub. Date: Oct. 7, 2004

(54) Fuel cell power system and method of operating the same

(75) Inventors: Todd A. Simpson, Brampton (CA); Joseph Cargnelli, Toronto (CA); Stephen Burany, Thornhill (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Hydrogenics Corporation, Mississauga (CA)

(21) Appl. No.: 10/722,578

(22) Filed: Nov. 28, 2003

Related U.S. Application Data
(60) Provisional application No. 60/429,318, filed on Nov. 27, 2002.

(51) Int. Cl. H01M 8/00; H01M 8/04; H01M 8/12

(52) U.S. Cl. 429/17; 429/13; 429/22; 429/23

(57) ABSTRACT

The present invention relates to a fuel cell system for producing electrical power and a method of operating same. The fuel cell has a first reactant inlet, a first reactant outlet, a second reactant inlet, and a second reactant outlet. The invention involves (a) providing a first reactant incoming stream to the first reactant inlet at a first reactant supply rate; (b) providing a second reactant incoming stream to the second reactant inlet at a second reactant supply rate; (c) conditioning at least one of the first reactant incoming stream and the second reactant incoming stream to a selected conditioning level; and, (d) selectably and temporarily reducing the selected conditioning level to increase at least one of the first reactant supply rate and the second reactant supply rate.

### FIELD OF THE INVENTION

The present invention relates generally to fuel cell power system and a method of operating a fuel cell power system. More particularly, the present invention relates to a method of operating a fuel cell system to increase instantaneous power output.

### BACKGROUND OF THE INVENTION

Fuel cell systems are seen as a promising alternative to traditional power generation technologies due to their low emissions, high efficiency and ease of operation. Fuel cells operate to convert chemical energy into electrical energy. Proton exchange membrane fuel cells comprise an anode, a cathode, and a selective electrolytic membrane disposed between the two electrodes. In a catalyzed reaction, a fuel such as hydrogen, is oxidized at the anode to form cations (protons) and electrons. The ion exchange membrane facilitates the migration of protons from the anode to the cathode. The electrons cannot pass through the membrane and are forced to flow through an external circuit thus providing an electrical current. At the cathode, oxygen reacts at the catalyst layer, with electrons returned from the electrical circuit, to form anions. The anions formed at the cathode react with the protons that have crossed the membrane to form liquid water as the reaction product.

Proton exchange membranes require a wet surface to facilitate the conduction of protons from the anode to the cathode, and otherwise to maintain the membranes electrically conductive. It has been suggested that each proton that moves through the membrane drags at least two or three water molecules with it (U.S. Pat. No. 5,996,976). U.S. Pat. No. 5,786,104 describes in qualitative terms a mechanism termed “water pumping”, involving the transport of cations (protons) with water molecules through the membrane. As the current density increases, the number of water molecules moved through the membrane also increases. Eventually the flux of water being pulled through the membrane by the proton flux exceeds the rate at which water is replenished by diffusion. At this point the membrane begins to dry out, at least on the anode side, and its internal resistance increases. It will be appreciated that this mechanism drives water to the cathode side, and additionally the water created by reaction is formed at the cathode side. Nonetheless, it is possible for the flow of gas across the cathode side to be sufficient to remove this water, resulting in drying out on the cathode side as well. To maintain membrane conductivity, the surface of the membrane must remain moist at all times. Therefore, to ensure adequate efficiency, the process gases must be, on entering the fuel cell, at an appropriate humidity and at a suitable temperature for keeping the membrane moist. The range for suitable humidities and temperatures will depend on system requirements.

A further consideration is that there is an increasing interest in using fuel cells in transport and like applications, e.g. as the basic power source for cars, buses and even larger vehicles. Automotive applications are quite different from many stationary applications. For example in stationary applications, fuel cell stacks are commonly used as an electrical power source and are simply expected to run at a relatively constant power level for an extended period of time. In contrast, in an automotive environment, the actual power required from the fuel cell stack can vary widely. Additionally, the fuel cell stack supply unit is expected to respond rapidly to changes in power demand, whether these be demands for increased or reduced power, while maintaining high efficiencies. Further, for automotive applications, a fuel cell power unit is expected to operate under an extreme range of ambient temperature and humidity conditions.

All of these requirement are exceedingly demanding and make it difficult to ensure a fuel cell stack will operate efficiently under all the possible range of operating conditions. While the key issues are ensuring that a fuel cell power unit can always supply a high power level and at a high efficiency and simultaneously ensuring that it has a long life, accurately controlling humidity levels within the fuel cell power unit is necessary to meet these requirements. More particularly, it is necessary to control humidity levels in both the oxidant and fuel gas streams. Most known techniques of humidification are ill designed to respond to rapidly changing conditions, temperatures and the like. Many known systems can provide inadequate humidification levels, and may have high thermal inertia and/or large dead volumes, so as to render them incapable of rapid response to changing conditions.

There remains a need for a fuel cell gas management system that can offer rapid dynamic control of temperatures and relative humidities for incoming fuel cell process gases. More particularly, such a system should be highly efficient and be able to provide sufficient humidity over a wide variety of flow rates, for both the oxidant and fuel systems. Such a system should be capable of rapid response to power demands and providing high power output instantaneously.

### SUMMARY OF THE INVENTION

In accordance with a first aspect of the present invention, there is provided a fuel cell system for producing electrical power. The fuel cell system comprises (a) a fuel cell having a first reactant inlet, a first reactant outlet, a second reactant inlet, and a second reactant outlet; (b) a first reactant supply subsystem for supplying a first reactant incoming stream to the first reactant inlet of the fuel cell at a first reactant supply rate; (c) a second reactant supply subsystem for supplying a second reactant incoming stream to the second reactant inlet of the fuel cell at a second reactant supply rate; and (d) a conditioning component for conditioning at least one of the first reactant incoming stream and the second reactant incoming stream to a selected conditioning level. The selected conditioning level is reducible to increase at least one of the first reactant supply rate and the second reactant supply rate.

In accordance with a second aspect of the present invention, there is provided a method of operating a fuel cell system for producing electrical power. The fuel cell has a first reactant inlet, a first reactant outlet, a second reactant inlet, and a second reactant outlet. The method comprises (a) providing a first reactant incoming stream to the first reactant inlet at a first reactant supply rate; (b) providing a second reactant incoming stream to the second reactant inlet at a second reactant supply rate; (c) conditioning at least one of the first reactant incoming stream and the second reactant incoming stream to a selected conditioning level; (d) selectably and temporarily reducing the selected conditioning level to increase at least one of the first reactant supply rate and the second reactant supply rate.

### BRIEF DESCRIPTION OF THE DRAWINGS

For a better understanding of the present invention, and to show more clearly how it may be carried into effect, reference will now be made, by way of example, to the accompanying drawings, which show a preferred embodiment of the present invention and in which:

FIG. 1 illustrates a schematic flow diagram of a first embodiment of a fuel cell gas and water management system according to the present invention;

FIG. 2, in a schematic flow diagram, illustrates a second embodiment of a fuel cell gas and water management system to which aspects of the present invention may be applied;

FIG. 3, in a partial schematic flow diagram, illustrates a third embodiment of a fuel cell gas and water management system, which operates under high pressure, to which aspects of the present invention may be applied;

FIG. 4, in a partial schematic flow diagram, illustrates a fourth embodiment of a fuel cell gas and water management system to which aspects of the present invention may be applied;

FIGS. 5a and 5b, in partial schematic flow diagrams, illustrate the connection of two regenerative dryer devices of a fuel cell gas and water management system to which aspects of the present invention may be applied;

FIG. 6, in a partial schematic flow diagram, illustrates a pressure balancing mechanism of a fuel cell gas and water management system to which aspects of the present invention may be applied; and,

FIG. 7, in a block diagram, illustrates a controller of the fuel cell gas and water management system of FIG. 1.

### DETAILED DESCRIPTION OF ASPECTS OF THE INVENTION

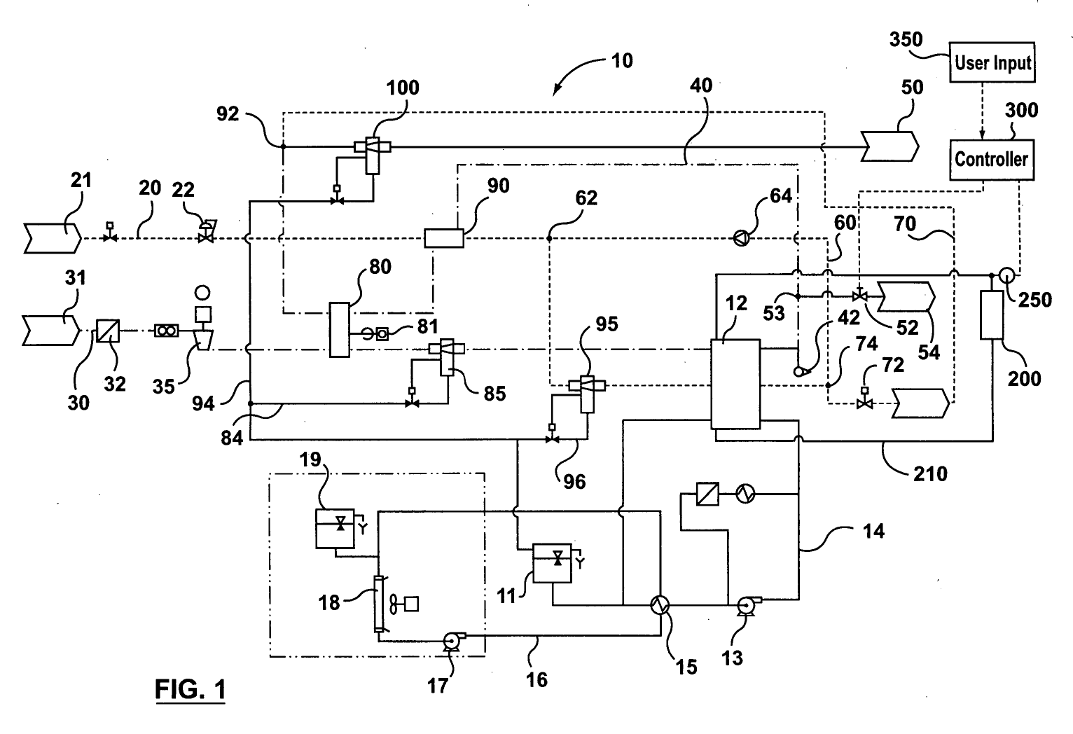

Referring first to FIG. 1, there is illustrated a schematic flow diagram of a first embodiment of a fuel cell gas management system 10 according to the present invention. The fuel cell gas management system 10 comprises a fuel supply line 20, an oxidant supply line 30, a cathode exhaust recirculation line 40 and an anode exhaust recirculation line 60, all connected to a fuel cell 12. It is to be understood that the fuel cell 12 may comprise a plurality of fuel cells or just a single fuel cell. For simplicity, the fuel cell 12 described herein operates on hydrogen as fuel and air as oxidant and can be a Proton Exchange Membrane (PEM) fuel cell. However, the present invention is not limited to this type of fuel cells and is applicable to other types of fuel cells that rely on other fuels and oxidants.

The fuel supply line 20 is connected to a fuel source 21 for supplying hydrogen to the anode of the fuel cell 12. A hydrogen humidifier 90 is disposed in the fuel supply line 20 upstream from the fuel cell 12 and an anode water separator 95 is disposed between the hydrogen humidifier 90 and the fuel cell 12. The oxidant supply line 30 is connected to an oxidant source 31, e.g. ambient air, for supplying air to the cathode of the fuel cell 12. A regenerative dryer 80 is disposed in the oxidant supply line 30 upstream of the fuel cell 12 and also in the cathode recirculation line 40. A cathode water separator 85 is disposed between the regenerative dryer 80 and the fuel cell 12. The regenerative dryer 80 can comprise porous materials with a desiccant and may be any commercially available dryer suitable for fuel cell system. The regenerative dryer 80 has a switch means to allow gases from the oxidant supply line 30 and the oxidant recirculation line 40 to alternately pass through the regenerative dryer 80 to exchange heat and humidity. Dry ambient air enters the oxidant supply line 30 and first passes through an air filter 32 that filters out the impurity particles. A blower 35 is disposed upstream of the regenerative dryer 80, to draw air from the air filter 32 and to pass the air through the regenerative dryer 80.

A fuel cell cathode exhaust stream contains excess air, product water and water transported from the anode side, the air being nitrogen rich due to consumption of at least part of the oxygen in the fuel cell 12. The cathode exhaust stream is recirculated through the cathode exhaust recirculation line 40 connected to the cathode outlet of the fuel cell 12. The humid cathode exhaust stream first passes through a hydrogen humidifier 90 in which the heat and humidity is transferred to incoming dry hydrogen in the fuel supply line 20. The hydrogen humidifier 90 can be any suitable humidifier, such as that commercially available from Perma Pure Inc, Toms River, N.J. It may also be a membrane humidifier and other types of humidifier with either high or low saturation efficiency. In fact, the hydrogen humidifier 90 is also a regenerative dryer, however, in view of the different gases in the anode and cathode streams, regenerative dryers or other devices that permit significant heat mass interchange between the two streams cannot be used.

From the hydrogen humidifier 90, the fuel cell cathode exhaust stream continues to flow along the recirculation line 40 and passes through the regenerative dryer 80, as mentioned above. As the humid cathode exhaust passes through the regenerative dryer 80, the heat and moisture is retained in the porous paper or fiber material of the regenerative dryer 80. After the porous paper or fiber material of the regenerative dryer 80 has been humidified by the humid cathode exhaust passing therethrough, the switch means of the regenerative dryer 80 switches the connection of the regenerative dryer 80 from the cathode exhaust stream to the incoming air stream, and the humidity retained in the porous paper or fiber material of the regenerative dryer 80 is then transferred to the incoming dry air stream passing through the regenerative dryer 80 in the oxidant supply line 30. Concurrently the cathode exhaust stream continues to flow along the recirculation line 40 to an exhaust water separator 100 in which the excess water, again in liquid form, that has not been transferred to the incoming hydrogen and air streams is separated from the exhaust stream. Then the exhaust stream is discharged to the environment along a discharge line 50.

A cathode outlet drain line 42 may optionally be provided in the recirculation line 40 adjacent the cathode outlet of the fuel cell to drain out any liquid water remaining or condensed out. The cathode outlet drain line 42 may be suitably sized so that gas bubbles in the drain line actually retain the water in the cathode outlet drain line and automatically drain water on a substantially regular basis, thereby avoiding the need of a drain valve that is commonly used in the field to drain water out of gas stream. Such a drain line can be used anywhere in the system where liquid water needs to be drained out from gas streams.

The humidified hydrogen from the hydrogen humidifier 90 flows along the fuel supply line 20 to the anode water separator 95 in which excess water is separated before the hydrogen enters the fuel cell 12. Likewise, the humidified air from the regenerative dryer 80 flows along the oxidant supply line 30 to the cathode water separator 85 in which excess liquid water is separated before the air enters the fuel cell 12.

Fuel cell anode exhaust comprising excess hydrogen and water is recirculated by a recirculation pump 64 along the anode recirculation line 60 connected to the anode outlet of the fuel cell 12. The anode recirculation line 60 connects to the fuel supply line 20 at a first joint 62 upstream from the anode water separator 95. The recirculation of the excess hydrogen together with water vapor not only permits utilization of hydrogen to the greatest possible extent and prevents liquid water from blocking hydrogen reactant delivery to the reactant sites, but also achieves self-humidification of the fuel stream since the water vapor from the recirculated hydrogen humidifies the incoming hydrogen from the hydrogen humidifier 90. This is highly desirable since this arrangement offers more flexibility in the choice of hydrogen humidifier 90 as the humidifier 90 does not then need to be a highly efficient one in the present system. By appropriately selecting the hydrogen recirculation flow rate, the required efficiency of the hydrogen humidifier 90 can be minimized. For example, supposing the fuel cell 12 needs one unit of hydrogen, hydrogen in the amount of three units can be passed through the fuel cell 12 with one unit of hydrogen being consumed while the two units of excess hydrogen are recirculated together with water vapor. The speed of recirculation pump 64 may be varied to adjust the portion of recirculated hydrogen in the mixture of hydrogen downstream from the first joint 62. The selection of stoichiometry and recirculation pump 64 speed may eventually lead to the omission of the hydrogen humidifier 90.

In practice, since air is used as oxidant, it has been found that nitrogen crossover from the cathode side of the fuel cell to the anode side can occur, e.g. through the membrane of a PEM fuel cell. Therefore, the anode exhaust actually contains some nitrogen and possibly other impurities. Recirculation of anode exhaust may result in the build-up of nitrogen and poison the fuel cell. Preferably, a hydrogen purge line 70 branches out from the fuel recirculation line 60 from a branch point 74 adjacent the fuel cell cathode outlet. A purge control device 72 is disposed in the hydrogen purge line 70 to purge a portion of the anode exhaust out of the recirculation line 60. The frequency and flow rate of the purge operation is dependent on the power on which the fuel cell 12 is running. When the fuel cell 12 is running on high power, it is desirable to purge a higher portion of anode exhaust. The purge control device 72 may be a solenoid valve or other suitable device.

The hydrogen purge line 70 runs from the branch point 74 to a second joint 92 at which it joins the cathode exhaust recirculation line 40. Then the mixture of purged hydrogen and the cathode exhaust from the regenerative dryer 80 passes through the exhaust water separator 100. Water is condensed in the water separator 100 and the remaining gas mixture is discharged to the environment along the discharge line 50. Alternatively, either the cathode exhaust recirculation line 40 or the purge line 70 can be connected directly into the water separator 100. It is also known to those skilled in the art that the purged hydrogen or the cathode exhaust from the regenerative dryer 80 can be separately discharged without condensing water therefrom.

Preferably, water separated by the anode water separator 95, cathode water separator 85, and the exhaust water separator 100 are not discharged, but rather the water is recovered respectively along anode inlet drain line 96, cathode inlet drain line 84 and discharge drain line 94 to a product water tank 97, for use in various processes. For this purpose, the tank 97 includes a line 98 for connection to other processes and a drain 99.

As is known to those skilled in the art, a first cooling loop 14 runs through the fuel cell 12. A first coolant pump 13 is disposed in the first cooling loop 14 for circulating the coolant. The coolant may be any coolant commonly used in the field, such as any non-conductive water, glycol, etc. A first expansion tank 11 can be provided in known manner. A first heat exchanger 15 is provided in the first cooling loop 14 for cooling the coolant flowing through the fuel cell 12 to maintain the coolant in an appropriate temperature range.

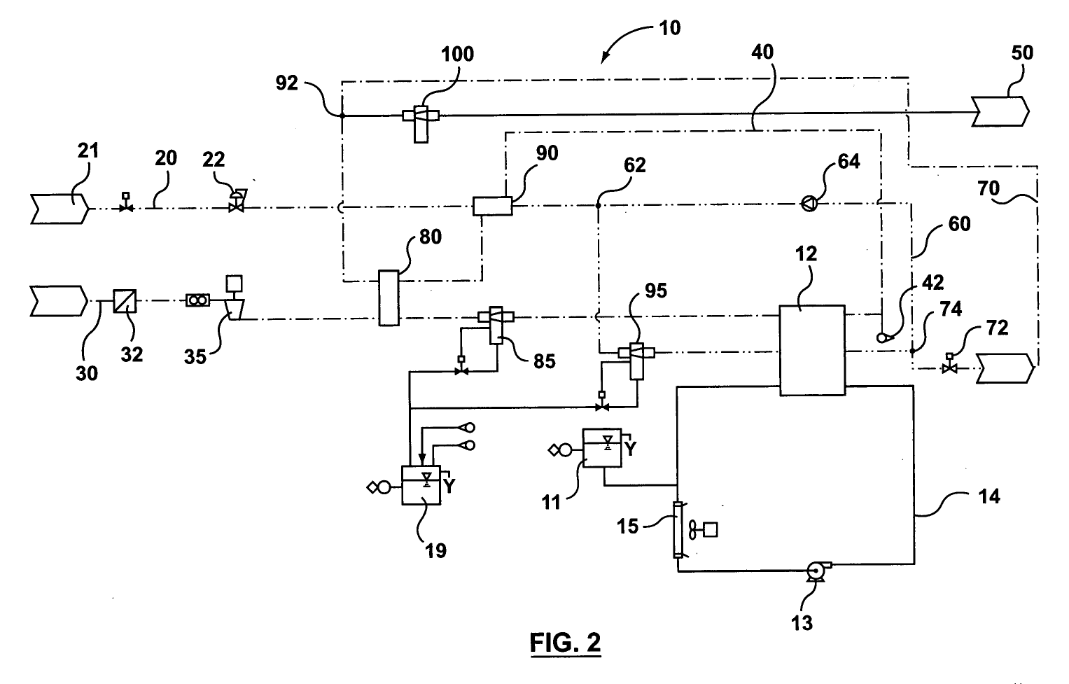

FIG. 1 shows one variant, in which a second cooling loop 16 includes a second coolant pump 17, to circulate a second coolant. A second heat exchanger 18, e.g. a radiator, is provided to maintain the temperature of the coolant in the second cooling loop and again, where required, a second tank 19 (shown in FIG. 2) is provided. The coolant in the second cooling loop 16 may be any type of coolant as the first and second cooling loops 14 and 16 do not mix. However, it is to be understood that the separate second cooling loop is not essential.

Referring to FIG. 2, there is illustrated in a schematic flow diagram an alternative fuel cell gas and water management system. In FIG. 2, components similar to the components illustrated in FIG. 1 are indicated using the same reference numerals, and for simplicity and brevity, the description of these components is not repeated. As shown in FIG. 2, a heat exchanger is provided in the first cooling loop 14 to maintain the temperature of the coolant in the first cooling loop 14 at a desired level. In this case, the second cooling loop 16 is omitted. It is to be understood that the heat exchanger 15 in FIG. 1 could also be an isolation, brazed plate heat exchanger disposed in an “open” cooling loop, as may be desired in some applications. That is to say, the second cooling loop 16 can be an open cooling loop in which coolant is drawn from and returned to a coolant reservoir, such as atmosphere, sea, etc.

When water is used as coolant in either of the above variants, since the water from the separators 95, 85, 100 is product water from the fuel cell, and hence pure and non-conductive, it can be collected and directed to the expansion tank 11 or 19, or coolant reservoir as coolant during the fuel cell operation.

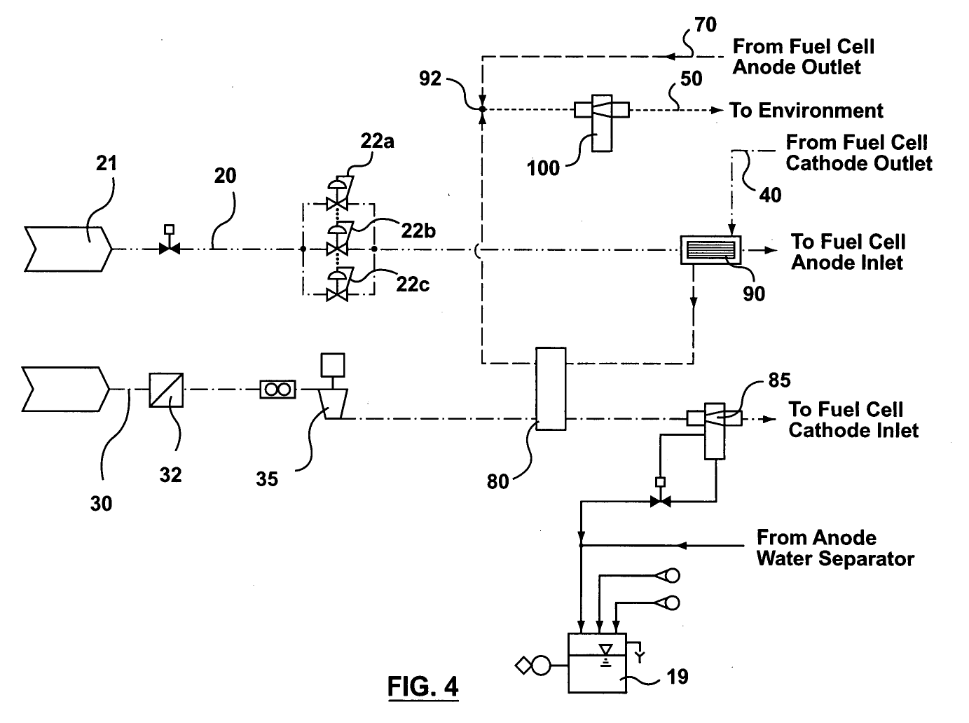

Preferably, a flow regulating device 22 is disposed in the fuel supply line 20 upstream from the hydrogen humidifier 90. The flow regulating device or valve 22 permits the flow of hydrogen from the hydrogen source 21 to the fuel cell 12 in response to the pressure drop in the fuel supply line 20. The flow regulating device 22 may be a forward pressure regulator having a set point that permits hydrogen to be supplied to the fuel cell 12 when the pressure in the fuel supply line 20 is below the set point due to the hydrogen consumption in the fuel cell 12. This forward pressure regulator avoids the need for an expensive mass flow controller and provides more rapid response and accurate flow control. Referring to FIG. 4, to provide more control flexibility, the flow regulating means 22 may comprise a plurality of pre-set forward pressure regulators arranged in parallel with each forward pressure regulator having a different set point. For example, a first forward pressure regulator 22a may have a set point of 10 Psig, a second forward pressure regulator 22b may have a set point of 20 Psig, a third forward pressure regulator 22c may have a set point of 30 Psig, and so on. This makes it possible to operate the fuel cell 12 with fuel supplied at different pressures and different rates at each pressure, without the need of interrupting the operation and changing the set point of the forward pressure regulator. The pressure regulators 22a, 22b and 22c are integrated internal shutoff valves, such that when one pressure regulator is open, the other pressure regulators are closed. For example, when the pressure regulator 22a is opened to provide downstream pressure of 10 Psig, the pressure regulators 22b and 22c will be closed.

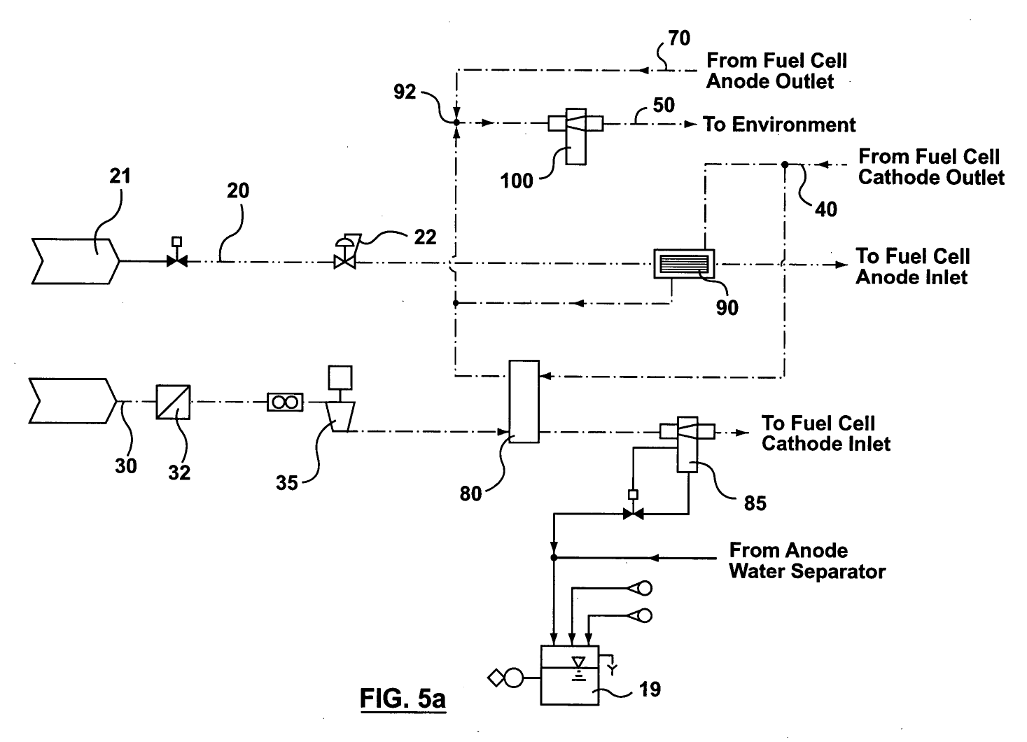

It is to be understood that although in this embodiment, the cathode exhaust is used to first humidify the incoming hydrogen and then the incoming air, this order is not essential. Instead, the cathode exhaust may be used to first humidify the incoming air and then the incoming hydrogen. Alternatively, as shown in FIG. 5a, the hydrogen humidifier 90 and the regenerative dryer 80 may be placed in parallel instead of series in the cathode exhaust recirculation line 60, so that the humidification of both hydrogen and air occurs simultaneously. Optionally, depending on the operation condition of the fuel cell 12, when the serial humidification is employed, a bypass line 82 may be further provided, as shown in FIG. 5b, to bypass the hydrogen humidifier 90 so that a portion of the cathode exhaust stream flows to the regenerative dryer 80 without passing through the hydrogen humidifier.

However, in practice it may be preferable to humidify hydrogen stream first since anode dew point temperature is desired to be higher than the cathode dew point temperature because water is naturally transferred from the anode to the cathode in the fuel cell 12. The desired relative humidity of hydrogen is also often higher than that of air in the fuel cell 12 so that the fuel cell 12 will not be flooded. Therefore, it is preferable to use the cathode exhaust stream to exchange heat and humidity with incoming hydrogen stream first.

In known manner, various sensors can be provided for measuring parameters of the stream of fuel, oxidant and coolant, supplied to the fuel cell 12. Optionally, the sensors can measure just the temperature of the reactants. The humidity would then be determined from known temperature—humidity characteristics, i.e. without directly measuring humidity.

It can be appreciated that it is not essential to over saturate process gases, condense water out to obtain 100% relative humidity and then deliver the process gases at certain temperature to get desired relative humidity before they enter the fuel cell 12, as in the applicant's co-pending U.S. patent application Ser. No. 09/801,916. The present system is applicable to fuel cell systems where fuel and oxidant stream either have or do not have 100% relative humidity. An anode dew point heat exchanger and a cathode dew point heat exchanger may be provided to control the humidity of fuel and oxidant when the fuel cell 12 is not operable with fuel or oxidant having 100% relative humidity. However, this totally depends on the characteristic of the fuel cell 12, such as the operating condition of the proton exchange membrane.

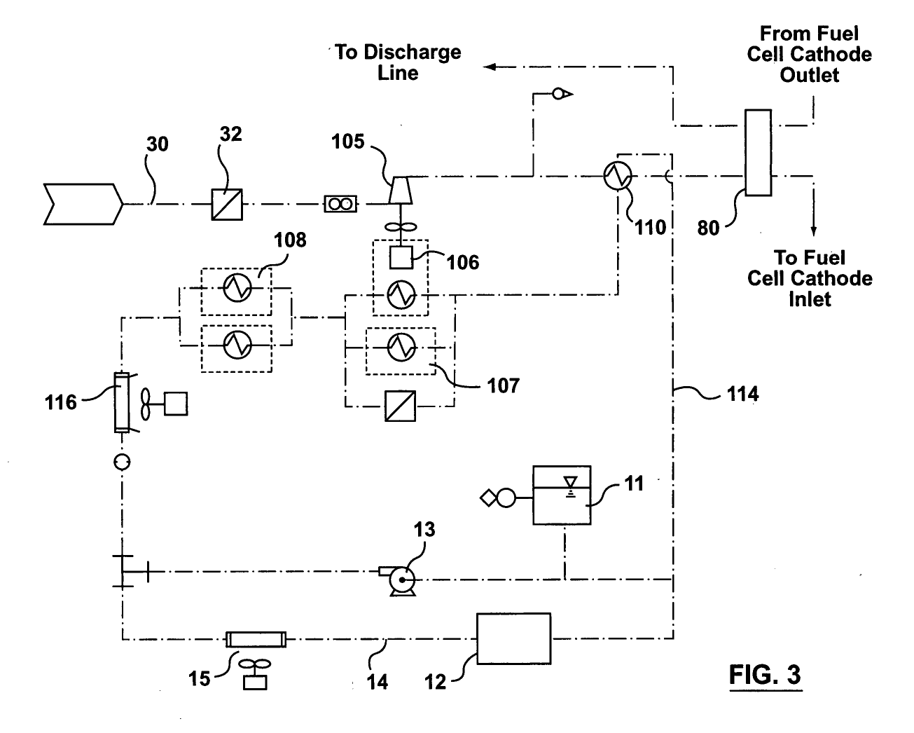

It is also to be understood that this first embodiment of the fuel cell system to which the present invention can be applied operates under ambient pressure or near ambient pressure. Referring to FIG. 3, there are illustrated cooling loops for use in a third fuel cell system to which the present invention can be applied that operates under high pressure, i.e. greater than atmospheric pressure.

In the third fuel cell system, similar components are indicated with same reference numbers, and for simplicity and brevity, the description of those components is not repeated.

In this third fuel cell system, a high pressure compressor 105 is provided in the oxidant supply line 30 upstream from the regenerative dryer 80 to pressurize the incoming air from the air filter 32. An after cooler heat exchanger 110 is provided between the compressor 105 and the regenerative dryer 80 to cool the compressed air having an elevated temperature. Hence, in addition to the first cooling loop 14 for the fuel cell 12, a third cooling loop 114 is provided including the after cooler heat exchanger 110 in the form of a water-water heat exchanger. The third cooling loop 114 may also run through a compressor motor 106, a compressor motor controller 107 and a power switching board 108 for the compressor 105, for cooling these components. The coolant in both first and third cooling loops 14 and 114 is driven by the first coolant pump 13. Similar to the radiator 18 in a second cooling loop, a radiator 116 with a powered fan is provided in the third cooling loop 114. This radiator 116 could optionally be replaced by a different heat exchange mechanism.

Regardless of the pressure under which the fuel cell system is operating, it is often preferably to balance the pressure of both fuel stream and oxidant stream supplied to the fuel cell 12. This ensures no significant pressure gradient exists within the fuel cell 12 and hence prevents damage of the fuel cell and prevents flow of reactants and coolants in undesired directions caused by pressure gradient. In addition, this also ensures proper stoichiometry of fuel and oxidant is supplied to the fuel cell 12 for reaction.

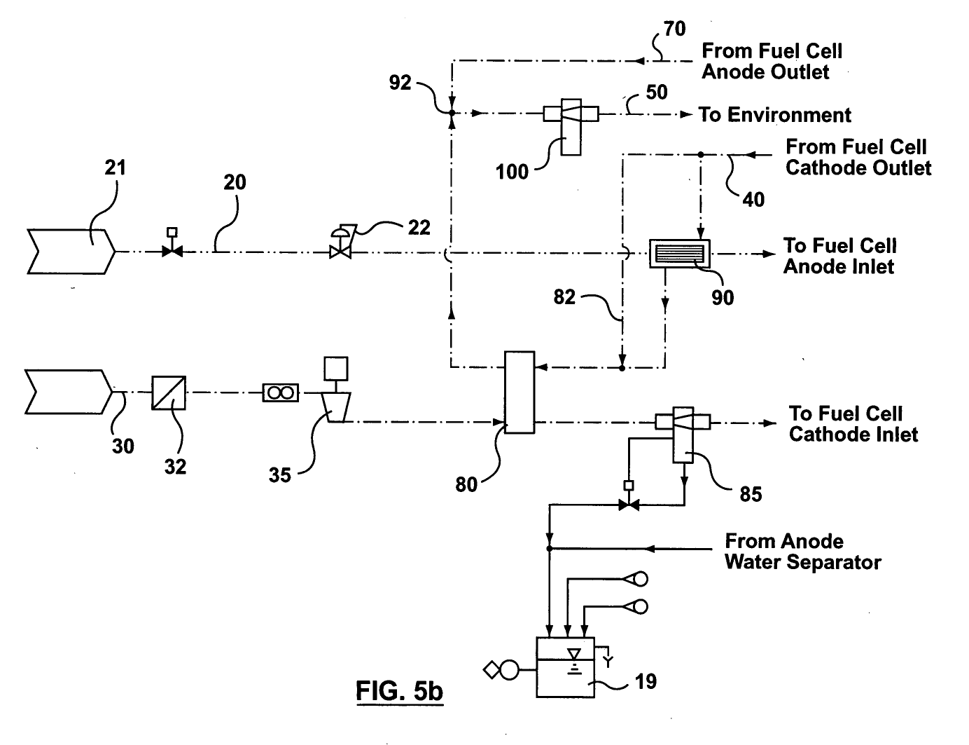

In the fuel cell systems illustrated, this is done by providing a balance pressure regulator 22′ and a pressure balancing line 25 between the fuel supply line 20 and the oxidant supply line 30, as shown in FIG. 6. The pressure balancing line 25 fluidly connects the balance pressure regulator 22′ disposed in the fuel supply line 20 upstream of the hydrogen humidifier 90, and a third joint 102 in the oxidant supply line 30 upstream of the regenerative dryer 80. The balance pressure regulator 22′ can still be a forward pressure regulator. However, it has to be adapted to work with two fluid streams and serves to balance the pressure between the two fluid streams. An example of this balance pressure regulator 22′ is disclosed in the applicant's co-pending U.S. patent application Ser. No. 09/961,092, incorporated herein by reference. Generally, such balance pressure regulator 22′ regulates the hydrogen flow in response to the pressure of air stream introduced by the pressure balancing line 25, and achieves mechanical balance until the pressure of hydrogen flow is regulated to be equal to that of the air flow.

It can be appreciated that the pressure balancer can be disposed in oxidant supply line 30 so that the pressure of the air stream can be regulated in response to that of the hydrogen stream. However, in practice it is convenient to set the pressure of the air stream by a choosing suitable speed or capacity of blower or compressor and to change the pressure of the hydrogen stream accordingly. Hence, it is preferred to make the pressure of hydrogen stream track that of the air stream. In some systems, the pressure balance between two reactant incoming streams are set manually or by a controller. However, the present configuration automatically ensures the pressure balance.

As mentioned above, in automobile applications, a fuel cell system is desired to provide instantaneous high power output in response to abruptly increased power demand under certain driving conditions. Such increased power demand usually lasts for a short period of time, for example, one minute. In order for the fuel cell 12 to increase its power output, increased amount of reactants have to be supplied to the fuel cell 12.

In the present invention, each of the regenerative dryer 80 and the hydrogen humidifier 90 has counter-flowing process gases therein. Although this provides humidification of incoming fuel and oxidant for fuel cell 12 and utilizes exhaust heat and humidity, the flow rates of incoming fuel and oxidant streams are usually limited in a certain range by the regenerative dryer 80 and hydrogen humidifier 90. In other words, when power demand instantaneously increases, the incoming flow rates of reactants will not increase correspondingly and the fuel cell system cannot deliver the desired power. Even if the blower or compressor in the incoming reactant stream is able to respond fast enough to increase the reactant supply to the fuel cell 12, the regenerative dryer 80 and hydrogen humidifier 90 tend to impede the amount of reactant actually supplied to the fuel cell 12 since the exchange of heat and humidity occurring within the regenerative dryer 80 and hydrogen humidifier 90 takes some time.

In the present invention, this problem can be overcome by pausing the recirculation of cathode exhaust for a short period of time when an abrupt increase of power demand occurs. While the incoming fuel and oxidant streams continue to be supplied to the regenerative dryer 80 and hydrogen humidifier 90, pausing the recirculation of cathode exhaust reduces the impediment provided by the regenerative dryer 80 and hydrogen humidifier 90, thereby allowing the incoming fuel and oxidant streams to be supplied to the fuel cell 12 at a higher flow rate, which in turn enables the fuel cell 12 to deliver a higher power output. After a short period of time, the recirculation is resumed to ensure incoming streams are properly humidified to prevent the membrane of the fuel cell 12 from drying out.

As shown in FIG. 1, a cathode purge line 54 branches out from the recirculation line 40 at a branch point 53 adjacent the cathode outlet of the fuel cell 12 and a cathode purge means 52 is provided for the cathode exhaust stream in the cathode purge line 54. Similar to the purge control device 72, the cathode purge means 52 can be a valve or other suitable devices. When high power output is desired, the purge means 52 opens to discharge cathode exhaust and hence reduce the amount of cathode exhaust stream recirculated. Preferably, the purge means 52 can regulate the amount of cathode exhaust purged. By this means, the amount of cathode exhaust provided to the regenerative dryer 80 and hydrogen humidifier can be continuously varied, thereby continuously varying the extent to which the regenerative dryer 80 and the hydrogen humidifier 90 tend to impede the flow of the incoming reactant streams into the fuel cell 12, which, in turn, helps to determine the rate at which increased power can be provided by the fuel cell 12. In addition, the back pressure in the oxidant supply line 30 can be continuously varied by opening the purge means 52 to different extents. Hence, by opening purge means 52 to different extents, the flow of both reactants can be increased by reducing the pressure drop at the regenerative dryer 80 and the hydrogen humidifier 90, and the flow of oxidant can be further increased by reducing the back pressure in the oxidant supply line 30, thereby enabling different power demands to be met. The purge operation can be done manually, or automatically by a system controller.

Instead of reducing the amount of cathode exhaust provided to the regenerative dryer 80 and hydrogen humidifier 90 to reduce the pressure drop imposed on the incoming reactants by these conditioning components, conditioning components such as the regenerative dryer 80 and hydrogen humidifier 90 can be fully or partially bypassed altogether by the incoming reactants. However, this approach has the drawback that the incoming reactant streams will not be humidified at all.

In addition, other conditioning components such as the cathode water separator 85, the anode water separator 95, and cooling components (not shown) downstream from the regenerative dryer 80 and hydrogen humidifier 90 for cooling down the reactants after humidification, can also be bypassed to increase the inflow of reactants to the fuel cell 12. In general, any conditioning component, that is any component having to do with water management, could be bypassed. Such components might control pressure, temperature, flow, water production or humidification, as well as back pressure. This can be done whether or not the regenerative dryer 80 and hydrogen humidifier 90 are bypassed, or the amount of cathode exhaust provided to the regenerative dryer 80 and hydrogen humidifier 90 is reduced.

Although not shown in the drawings, it will be appreciated by those skilled in the art that the purge means 72 can be a three-way valve provided at the branch point 53 in the recirculation line 40, which in one position allows cathode exhaust to be recirculated along line 40 and in the other position, cuts off the recirculation line 40 and directs the cathode exhaust along cathode purge line 54. In this case, when high power demand occurs, recirculation of cathode exhaust stream completely stops.

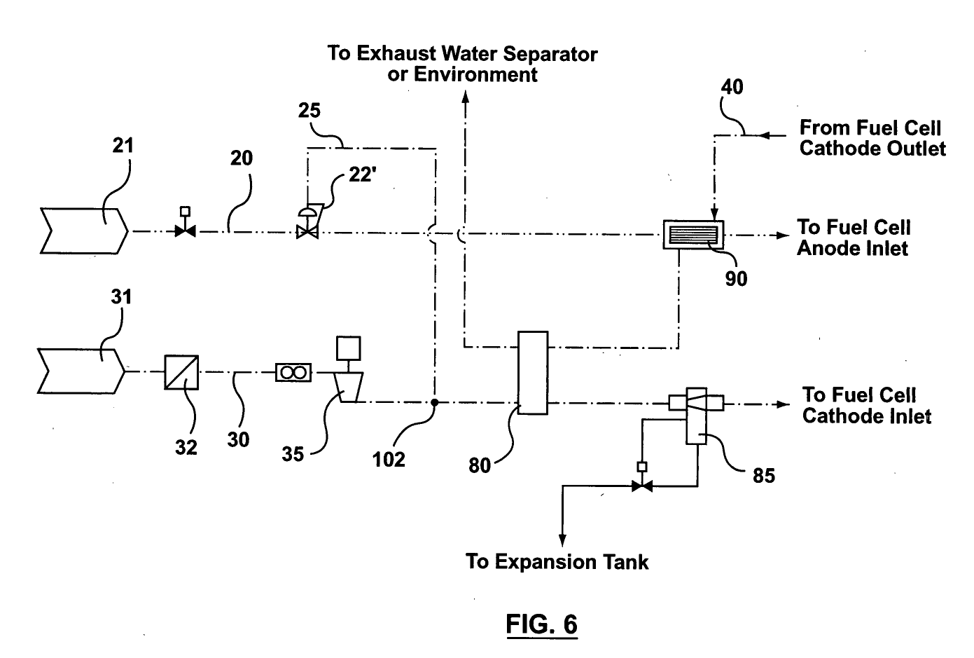

Still referring to FIG. 1, the fuel cell system can have a controller 300, whether a central controller that controls various components of fuel cell system, such as coolant pump, blowers, pressure regulators, or a local controller that only controls the operation of the purge means 52. The fuel cell 12 drives a load 200 via a power electrical circuit 210. When a higher power output is desired, the user sends a signal via a user input device 350 to the controller 300 that operates the purge means accordingly. Alternatively, the controller monitors the condition of the power electrical circuit 210 and controls the purge operation accordingly. For example, the controller 300 reads monitored values of flow and pressure of the fluids that the blower 35 provides to the fuel cell 12. The controller 300 may also read the current that the load 200 draws from the fuel cell 12 through, for example, an amperemeter 250. When the rate at which the load current changes is beyond a certain level, or the load 200 current itself has changed beyond a certain level, the controller 300 controls the purge means 52 to open. Such power demand threshold or change in power demand threshold is, in the case of automatic operation, predetermined and stored in the controller 300. Referring to FIG. 7, there is illustrated in a block diagram, the controller 300 of FIG. 1. As shown, the controller 300 includes a linkage module 306 for linking the controller 300 to a plurality of flow control devices 312. The plurality of flow control devices 312 may include, for example, the purge means 52, as well as various bypass devices for enabling reactant inflows to fully or partially bypass conditioning components such as the regenerative dryer 80 and the hydrogen humidifier 90.

Controller 300 is also linked by the linkage module 306 to measurement devices 311. Typically, as described above, measurement devices 311 could include amperemeter 250, as well as pressure sensors for determining the pressure of reactant inflows supplied to the fuel cell 12.

Fuel cell operation information is stored in the storage module 302. The fuel cell operation information would include information on the reactant inflows required to meet certain loads, as well as sharp fluctuations in the load. When there is a sharp increase in either a load or the rate of change in a load, this information will be communicated from amperemeter 250 to linkage module 306. Alternatively, if there is a sharp drop in the pressure of the incoming reactants, this information will also be communicated by measurement devices 311 to linkage module 306. Alternatively, a user may, via user input 350, send a signal to the linkage module 306 indicating that the load on the fuel cell 12 is about to sharply increase. This user input can be provided before any measurements would indicate that increased reactant flow is required.

Based on the information received in the linkage module and the information regarding fuel cell operations stored in the storage module 302, a logic module 308 linked to both the linkage module 306 and storage module 302 can determine the increase in reactant inflows required. Then, via linkage module 306, the logic module 308 can instruct flow control devices 312 to increase the incoming reactant flow rate in the manner described above.

More specifically, in the case of automatic operation, the storage module 302 stores a power demand threshold and a change in power demand threshold. Measurement devices 311 such as the amperemeter 250 monitor the demand for power from the fuel cell, as well as the rate of change in the demand for power. The logic module 308 compares the demand for power output with the power demand threshold stored in the storage module 302. If this power demand exceeds the power demand threshold stored in the storage module 302, then the logic module 308 provides instructions to the flow control device 312 via the linkage module 306 to increase the reactant inflows. As described above, this may involve, for example, the logic module 308 instructing the purge means 52, to partially or fully purge the cathode exhaust to reduce the amount of cathode exhaust provided to the regenerative dryer 80 and hydrogen humidifier 90. This reduces the pressure drop of the incoming reactants at the regenerative dryer 80 and hydrogen humidifier 90 and also reduces the back pressure at the cathode exhaust, both of which tend to increase reactant inflows into the fuel cell 12.

Alternatively, the logic module 306 may instruct other flow control devices 312 to partially or fully bypass conditioning components such as the regenerative dryer 80 and the hydrogen humidifier 90 upstream from the fuel cell 12. Preferably, the extent to which cathode exhaust is purged by purge means 52, or the extent to which upstream conditioning components are bypassed are controlled by the logic module 308 based on the extent to which the demand for power output exceeds the power demand threshold, and the rate of change of demand for power output exceeds the change in power demand threshold. That is, if the demand for power output is only slightly above the power demand threshold, then only a partial purge by cathode purge means 52 may be required. Alternatively, however, if the demand for power output significantly exceeds the power output threshold, or the change in demand for power output significantly exceeds the change in power demand threshold, then logic module 308 can control cathode purge means 52 to fully purge the cathode exhaust.

While the above description constitutes the preferred embodiments, it will be appreciated that the present invention is susceptible to modification and change without departing from the fair meaning of the proper scope of the accompanying claims. For example, the present invention might have applicability in various types of fuel cells, which include but are not limited to, solid oxide, alkaline, molton-carbonate, and phosphoric acid. In particular, the present invention may be applied to fuel cells which operate at much higher temperatures. As will be appreciated by those skilled in the art, the requirement for humidification is very dependent on the electrolyte used and also the temperature and pressure of operation of the fuel cell. Accordingly, it will be understood that the present invention may not be applicable to many types of fuel cells.

1. A fuel cell system for producing electrical power, comprising:
a fuel cell having a first reactant inlet, a first reactant outlet, a second reactant inlet, and a second reactant outlet;
a first reactant supply subsystem for supplying a first reactant incoming stream to the first reactant inlet of the fuel cell at a first reactant supply rate;
a second reactant supply subsystem for supplying a second reactant incoming stream to the second reactant inlet of the fuel cell at a second reactant supply rate; and,
a conditioning component for conditioning at least one of the first reactant incoming stream and the second reactant incoming stream to a selected conditioning level, wherein the selected conditioning level is reducible to increase at least one of the first reactant supply rate and the second reactant supply rate.

2. The fuel cell system as defined in claim 1 further comprising
a monitoring device for monitoring at least one system variable; and,
a controller for increasing at least one of the first reactant supply rate and the second reactant supply rate by reducing the selected conditioning level in response to changes in the at least one system variable.

3. The fuel cell system as defined in claim 2 wherein the selected conditioning level is a selected humidification level and the reactant conditioning component is a reactant humidification component for humidifying at least one of the first reactant incoming stream and the second reactant incoming stream to the selected humidification level.

4. The fuel cell system as defined in claim 3 further comprising a first reactant recirculation subsystem for recirculating at least a portion of a first reactant exhaust stream from a first reactant outlet of the fuel cell to the reactant humidification component, wherein
the reactant humidification component is operable to transfer heat and moisture from the first reactant exhaust stream to at least one of the first reactant incoming stream and the second reactant incoming stream; and
the controller is operable to control the first reactant recirculation subsystem to temporarily reduce the portion of the first reactant exhaust stream recirculated to increase at least one of the first reactant supply rate and the second reactant supply rate.

5. A fuel cell system as claimed in claim 4, further comprising a first reactant purge means for purging the first reactant stream from the first reactant outlet, wherein, in response to changes in the at least one system variable, the controller is operable to control the first reactant purge means to purge at least a portion of the first reactant exhaust stream from the first reactant outlet.

6. A fuel cell system as claimed in claim 5, wherein
the at least one system variable comprises at least one of the first value representing the demand for power output and a second value representing the rate at which the demand for power output changes;
when the first value changes beyond a first predetermined level, the controller controls the first reactant purge means to purge and regulate the amount of the first reactant exhaust stream purged based on changes in the first value; and,
when the second value changes beyond a second predetermined level, the controller controls the first reactant purge means to purge and regulate the amount of the first reactant exhaust stream purged based on changes in the second value.

7. A fuel cell system as claimed in claim 4, further comprising a first reactant purge means, wherein the controller is operable to control the first reactant purge means to switch between a first position for recirculating the first reactant exhaust stream and a second position for purging the first reactant exhaust stream.

8. A fuel cell system as claimed in claim 7, wherein the at least one system variable comprises at least one of the first value representing the demand for power output and a second value representing the rate at which the demand for power output changes; when the first value changes beyond a first predetermined level, the controller controls the purge means to switch from the first position to the second position; and, when the second value changes beyond a second predetermined level, the controller controls the first reactant purge means to switch from the first position to the second position.

9. A fuel cell system as claimed in claim 3, wherein the reactant humidification component comprises a first regenerative dryer device for transferring at least a portion of the heat and moisture from the first reactant exhaust stream to the first reactant incoming stream in the first reactant supply subsystem, and a second regenerative dryer device for transferring at least a portion of the heat and moisture from the first reactant exhaust stream to the second reactant incoming stream in the second reactant supply subsystem.

10. The fuel cell system as defined in claim 1 further comprising a user input device for selectably reducing the selected conditioning level.

11. The fuel cell system as defined in claim 10 wherein the selected conditioning level is a selected humidification level and the reactant conditioning component is a reactant humidification component for humidifying at least one of the first reactant incoming stream and the second reactant incoming stream to the selected humidification level.

12. The fuel cell system as defined in claim 11 further comprising a first reactant recirculation subsystem for recirculating at least a portion of a first reactant exhaust stream from a first reactant outlet of the fuel cell to the reactant humidification component, wherein
the reactant humidification component is operable to transfer heat and moisture from the first reactant exhaust stream to at least one of the first reactant incoming stream and the second reactant incoming stream; and
the user input device is operable by a user to control the first reactant recirculation subsystem to temporarily reduce the portion of the first reactant exhaust stream recirculated to increase at least one of the first reactant supply rate and the second reactant supply rate.

13. A fuel cell system as claimed in claim 12, further comprising a first reactant purge means for purging the first reactant stream from the first reactant outlet, wherein, in response to instructions from the user input device, the first reactant purge means is operable to purge at least a portion of the first reactant exhaust stream from the first reactant outlet.

14. A fuel cell system as claimed in claim 11, wherein the reactant humidification component comprises a first regenerative dryer device for transferring at least a portion of the heat and moisture from the first reactant exhaust stream to the first reactant incoming stream in the first reactant supply subsystem, and a second regenerative dryer device for transferring at least a portion of the heat and moisture from the first reactant exhaust stream to the second reactant incoming stream in the second reactant supply subsystem.

15. A method of operating a fuel cell system for producing electrical power, the fuel cell having a first reactant inlet, a first reactant outlet, a second reactant inlet, and a second reactant outlet, said method comprising:
(a) providing a first reactant incoming stream to the first reactant inlet at a first reactant supply rate;
(b) providing a second reactant incoming stream to the second reactant inlet at a second reactant supply rate;
(c) conditioning at least one of the first reactant incoming stream and the second reactant incoming stream to a selected conditioning level;
(d) selectably and temporarily reducing the selected conditioning level to increase at least one of the first reactant supply rate and the second reactant supply rate.

16. The method as defined in claim 15 further comprising monitoring at least one system variable, wherein step (d) comprises increasing at least one of the first reactant supply rate and the second reactant supply rate by reducing the selected conditioning level in response to changes in the at least one system variable.

17. The method as defined in claim 16 wherein the selected conditioning level is a selected humidification level and step (c) comprises conditioning at least one of the first reactant incoming stream and the second reactant incoming stream to the selected humidification level.

18. The method as defined in claim 17 wherein step (c) comprises recirculating at least a portion of a first reactant exhaust stream from a first reactant outlet of the fuel cell to transfer heat and moisture from the first reactant exhaust stream to at least one of the first reactant incoming stream and the second reactant incoming stream; and step (d) comprises selectably and temporarily reducing the portion of the first reactant exhaust stream recirculated to increase at least one of the first reactant supply rate and the second reactant supply rate.

19. A method of operating a fuel cell system as claimed in claim 17, wherein step (d) comprises purging at least a portion of the first reactant exhaust stream from the first reactant outlet.

20. A method of operating a fuel cell system as claimed in claim 18, wherein step (d) further comprises reading at least one of the first value representing the demand for power output and a second value representing the rate at which the demand for power output changes and wherein when one of the first value changes beyond a first predetermined value and the second value changes beyond a second predetermined value, purging the first reactant exhaust stream and regulating the amount of the first reactant exhaust stream purged in response to the change in at least one of the first value and the second value.

21. A method of operating a fuel cell system as claimed in claim 20, wherein step (d) comprises purging all the first reactant exhaust stream from the reactant outlet.

22. A method of operating a fuel cell system as claimed in claim 21, wherein step (d) further comprises reading at least one of the first value representing the demand for power output and a second value representing the rate at which the demand for power output changes and wherein when one of the first value changes beyond a first predetermined value and the second value changes beyond a second predetermined level, purging all the first reactant exhaust stream from the reactant outlet.
